(19) United States
(12) Patent Application Publication
(10) Pub. No.: US 2019/0238693 A1
(43) Pub. Date: Aug. 1, 2019

(54) MANAGEMENT SERVER, IMAGE FORMING SYSTEM AND MANAGEMENT METHOD FOR MANAGING PLURAL IMAGE FORMING APPARATUSES VIA NETWORK

(71) Applicant: KYOCERA Document Solutions Inc., Osaka (JP)

(72) Inventors: Tatsuya HIWATARI, Osaka (JP); Masafumi SATO, Osaka (JP); Zhenyu SUN, Osaka (JP); Keiji TSUDA, Osaka (JP)

(73) Assignee: KYOCERA Document Solutions Inc., Osaka (JP)

(21) Appl. No.: 16/264,271

(22) Filed: Jan. 31, 2019

(30) Foreign Application Priority Data
Jan. 31, 2018 (JP) 2018-014944

(51) Int. Cl. H04N 1/00; G06F 3/12

(52) U.S. Cl. CPC H04N 1/00344; H04N 1/00244; G06F 3/1273; G06F 3/1288; G06F 3/126; G06F 3/1204

(57) ABSTRACT

Provided is a management server that flexibly filters report items under various conditions according to a customer environment. The management server manages a plurality of image forming apparatuses 3 via a network. The management server includes a management information database (management information DB), a filtering-setting-receiving unit, and a report-generating unit. The management information database registers job histories of the plurality of image forming apparatuses. The filtering-setting-receiving unit receives a filtering setting for the management information database by SQL. The report-generating unit executes the SQL received by the filtering-setting-receiving unit for the management information database and generates a report based on the job histories.

### INCORPORATION BY REFERENCE

This application is based on and claims the benefit of priority from Japanese Patent Application No. 2018-014944 filed on Jan. 31, 2018, the contents of which are hereby incorporated by reference.

### BACKGROUND

The present disclosure relates to a management server, an image forming system and a management method for managing a plurality of image forming apparatuses via a network.

When providing an image forming system to a customer, the management server may sometimes centrally manage a plurality of image forming apparatuses such as printers, copiers, multifunction peripherals and the like in a customer environment via a network. The management server can collect and accumulate the states of image forming apparatuses to be managed in a database, and can generate a report. As this kind of report output technique, for example, there is known a technique of automatically generating and executing SQL based on fields and parameters designated by a user, and reporting about the extraction results acquired from a database.

### SUMMARY

The management server according to the present disclosure is a management server that manages a plurality of image forming apparatuses via a network. The management server includes a management information database, a filtering-setting-receiving unit and a report-generating unit. The management information database registers job histories of the plurality of image forming apparatuses. The filtering-setting-receiving unit receives a filtering setting for the management information database by SQL. The report-generating unit executes the SQL received by the filtering-setting-receiving unit for the management information database and generates a report based on the job histories.

The image forming system according to the present disclosure is an image forming system in which a plurality of image forming apparatuses and a management server are connected via a network. The management server includes a management information database, a filtering-setting-receiving unit and a report-generating unit. The management information database registers job histories of the plurality of image forming apparatuses. The filtering-setting-receiving unit receives a filtering setting for the management information database by SQL. The report-generating unit executes the SQL received by the filtering-setting-receiving unit for the management information database and generates a report based on the job histories.

The management method according to the present disclosure is a management method executed by a management server that manages a plurality of image forming apparatuses via a network. The management method receives by SQL a filtering setting for a management information database in which job histories of the plurality of image forming apparatuses are registered. The management method executes the received SQL for the management information database and generates a report.

### BRIEF DESCRIPTION OF THE DRAWINGS

FIG. 1 is a system configuration diagram of an image forming system of an embodiment according to the present disclosure.

FIG. 2 is a schematic configuration diagram of the management server illustrated in FIG. 1.

FIG. 3 illustrates an example of registration of the individual queue setting information illustrated in FIG. 2.

FIG. 4 is a schematic configuration diagram of a user terminal illustrated in FIG. 1.

FIG. 5 is a flowchart illustrating flow of a process in which the management server illustrated in FIG. 1 receives an individual queue setting.

FIG. 6 is an example of the individual queue setting screen illustrated in FIG. 5.

FIG. 7 is a flowchart illustrating the flow of a printing process by the image forming system illustrated in FIG. 1.

FIG. 8 is a flowchart illustrating flow of a report generation process by the management server illustrated in FIG. 1.

FIG. 9 is an example of a setting screen that receives settings of filtering conditions by SQL.

### DETAILED DESCRIPTION

Hereinafter, embodiments of the present disclosure will be described in detail with reference to the drawings. Incidentally, in the following embodiments, the same reference numerals are given to configurations having similar functions.

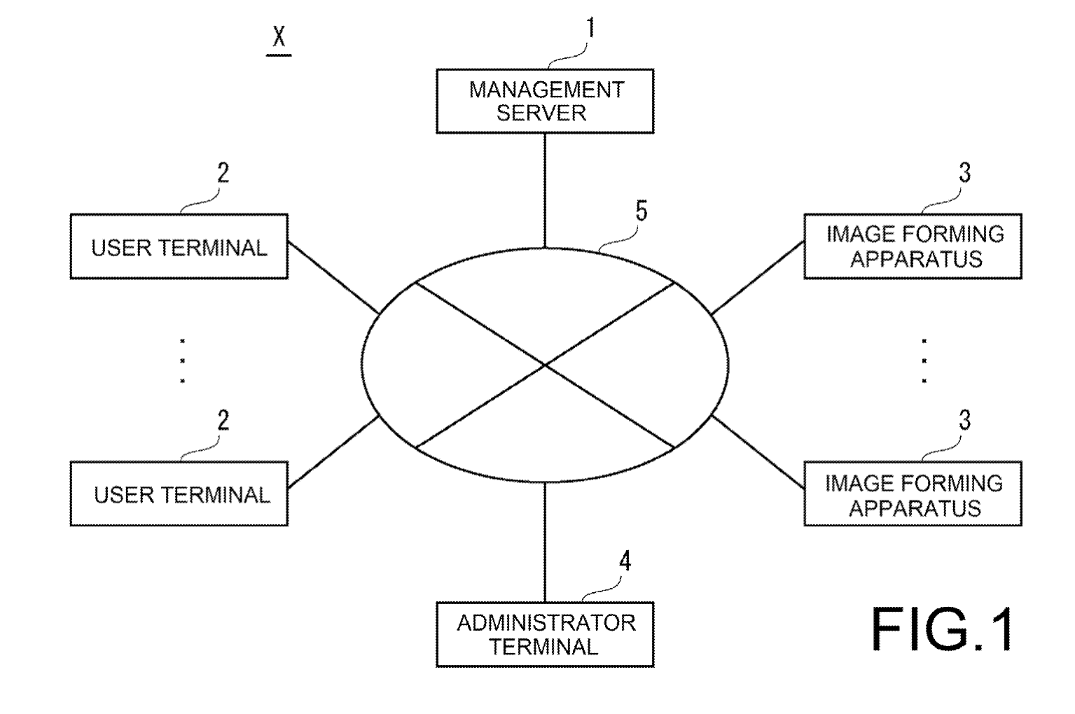

As illustrated in FIG. 1, in an image forming system X, a management server 1, a plurality of user terminals 2, a plurality of image forming apparatuses 3, and an administrator terminal 4 are connected via a network 5. The image forming apparatus 3 is a printer, a copier, a multifunction peripheral, or the like, and has a printing function.

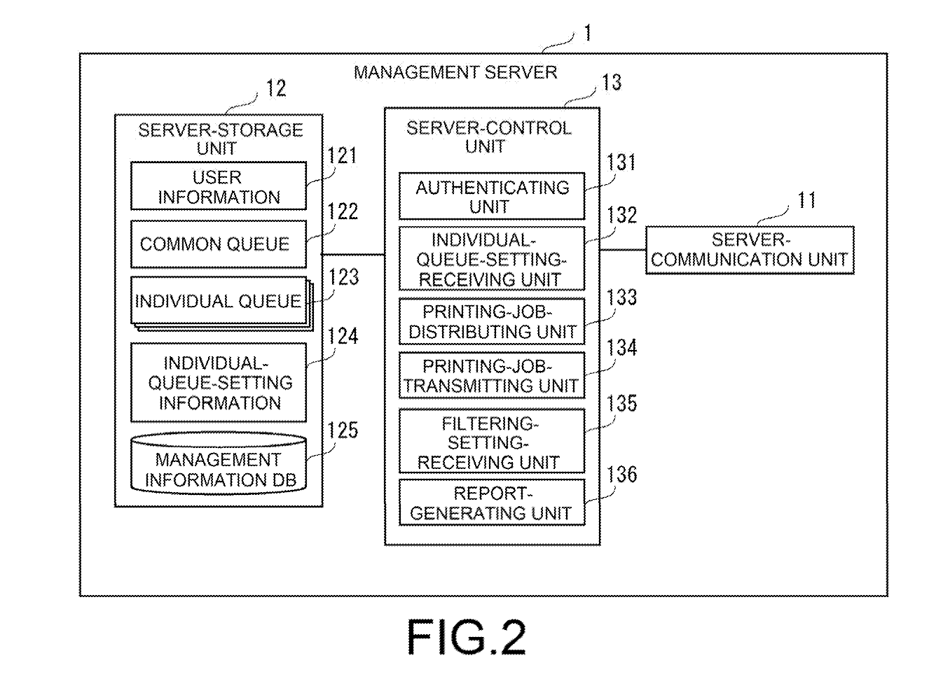

As illustrated in FIG. 2, the management server 1 includes a server-communication unit 11, a server-storage unit 12, and a server-control unit 13.

The server-communication unit 11 has a function of transmitting and receiving various data to and from a plurality of user terminals 2, a plurality of image forming apparatuses 3, and an administrator terminal 4 via a network 5 such as a LAN (Local Area Network), Internet or the like.

The server-storage unit 12 is a storage unit such as a semiconductor memory, HDD (Hard Disk Drive) or the like. The server-storage unit 12 includes user information 121, a common queue 122, a plurality of individual queues 123 corresponding to a plurality of image forming apparatuses 3 on a one-to-one basis, individual queue setting information 124, and a management information DB 125. In addition, the server-storage unit 12 also stores a system setting file (for example, a config.ini file, and the like).

In the user information 121, a user name (user ID), a password, and the like used for user authentication are registered.

The common queue 122 is a queue in which printing jobs transmitted from each user terminal 2 are temporarily stored.

The number of the plurality of individual queues 123 provided is the same as the number of the plurality of image forming apparatuses 3 to be managed by the management server 1, and corresponds to the plurality of image forming apparatuses 3 on a one-to-one basis.

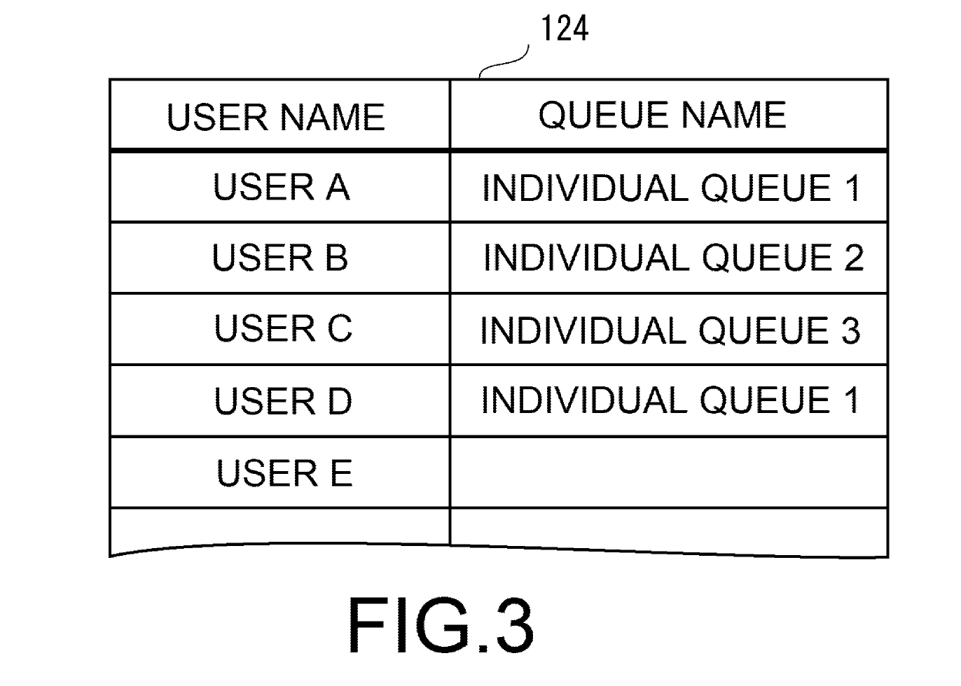

In the individual queue setting information 124, as illustrated in FIG. 3, an individual queue 123 corresponding to an image forming apparatus 3 as an output destination is registered for each user. A user whose queue name is blank like user E indicates that queue setting has not yet been completed.

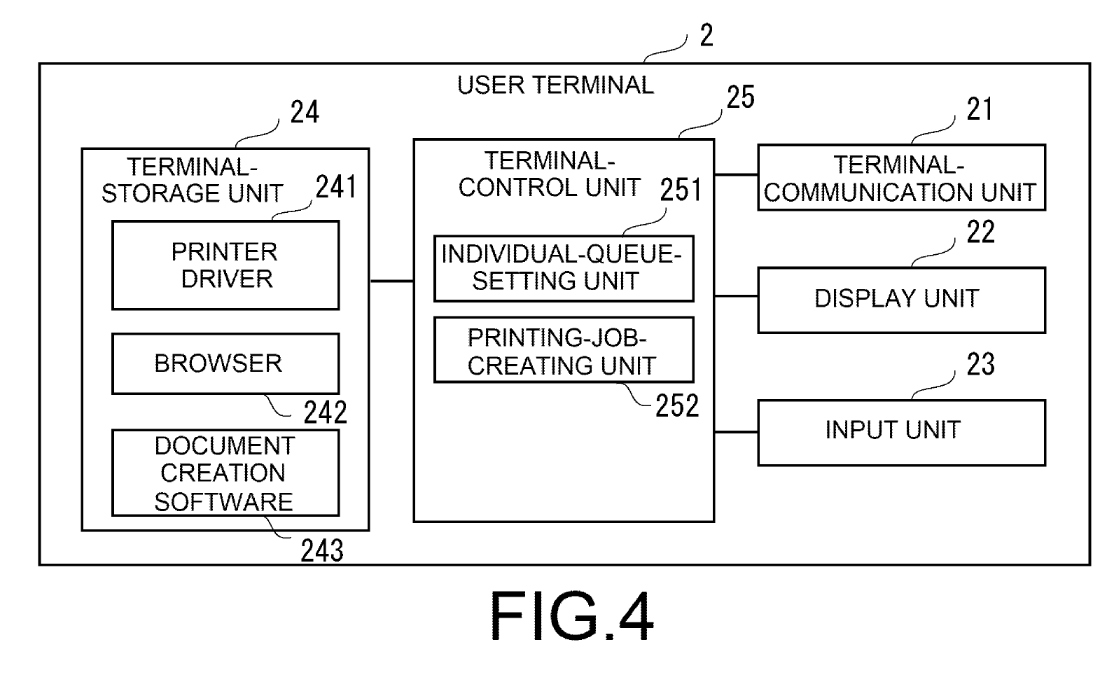

Normally, in the case of providing an image forming system X to customers, a serviceperson delivers each user terminal 2 of the customer environment in a state with the printer driver installed. Generally, the output destination of a printing job transmitted from a user terminal 2 is set by the printer driver setting to an individual queue 123 corresponding to any one of the plurality of image forming apparatuses 3. However, setting the output destination by the setting of the printer driver according to the usage state of each user places a heavy burden on the serviceperson. Therefore, in this embodiment, the output destinations of the printer driver 241 (FIG. 4) to be described later are commonly set in a common queue 122, and each user sets the individual queue 123 as the output destination.

A management information DB (management information database) 125 is a database in which states of a plurality of image forming apparatuses 3 to be managed by the management server 1 are registered. For example, the management information DB 125 registers serial numbers, IP addresses, functions (printing function, copying function, scanning function, FAX function, and the like), job history, and the like of each image forming apparatus 3.

The server-control unit 13 is an information processing unit such as a microcomputer or the like that includes a CPU (Central Processing Unit), a ROM (Read Only Memory), a RAM (Random Access Memory), and the like. The ROM stores a control program for performing operation control of the management server 1. The CPU of the server-control unit 13 reads the control program stored in the ROM, develops the control program in the RAM, and executes the control program, thereby performing overall control of the management server 1.

In addition, the server-control unit 13 functions as an authenticating unit 131, an individual-queue-setting-receiving unit 132, a printing-job-distributing unit 133, a printing-job-transmitting unit 134, a filtering-setting-receiving unit 135, and a report-generating unit 136.

The authenticating unit 131 has a function of performing user authentication by comparing authentication information such as a user name (user ID), a password or the like transmitted from the user terminal 2 or the image forming apparatus 3 via the network 5 with user information 121 stored in the server storage unit 12.

The individual-queue-setting-receiving unit 132 has a function of receiving an individual queue 123 setting as the output destination of a printing job for each user. Among a plurality of individual queues 123, a user can set an individual queue 123 as the output destination of a printing job.

The printing-job-distributing unit 133 monitors the storage state of the printing jobs of the common queue 122. In the case where printing jobs are stored in the common queue 122, the printing-job-distributing unit 133 has a function of distributing the printing jobs to the individual queue 123 associated with the user name included in the printing job based on the individual queue setting information 124.

The printing-job-transmitting unit 134 has a function of monitoring the storage state of the printing job of each individual queue 123, and transmitting the printing job stored in each individual queue 123 to the image forming apparatus 3 corresponding to the individual queue 123 via a server-communication unit 11. When the printing job is executed by the image forming apparatus 3, the executed job information is recorded in the management information DB 125 as a job history.

The filtering-setting-receiving unit 135, in the case where a user having report creation authority logs in, has a function of receiving a setting of a filtering condition to be extracted as a report target item from the management information DB 125. In the case where a advanced report output function is set to be usable, the filtering-setting-receiving unit 135 can receive the filtering setting by SQL. Therefore, since the filtering condition for the management information DB 125, which is a database, can be specified by SQL which is a database language, the filtering condition can be flexibly set, and thus the processing speed can be improved.

The report-generating unit 136 has a function of specifying a report target item from the management information DB 125 based on a filtering condition received by the filtering-setting-receiving unit 135, generating a report, and outputting the report.

Next, a schematic configuration of the user terminal 2 will be described with reference to FIG. 4.

The user terminal 2 is, for example, a personal computer, a tablet terminal, a smartphone, or the like, and includes a terminal-communication unit 21, a display-unit 22, an input unit 23, a terminal-storage unit 24, and a terminal-control unit 25.

The terminal-communication unit 21 has a function of transmitting and receiving various data to and from the management server 1 and a plurality of image forming apparatuses 3 via a network 5 such as a LAN, the Internet or the like.

The display unit 22 is a display unit such as a display or the like for displaying various kinds of information.

The input unit 23 is an input unit such as a mouse, a keyboard, a pointing device, or the like. The input unit 23 may be provided as a transparent touch sensor on the display surface of the display unit 22, and function as a touch panel together with the display unit 22. In addition, the input unit 23 may read an IC card such as an employee ID card or the like and acquire authentication information such as a user name or the like.

The terminal storage unit 24 is a storage unit such as a semiconductor memory, an HDD, or the like and stores a printer driver 241, a browser 242, and document creation software 243.

The printer driver 241 is an application program for creating a printing job according to an operation instruction of the user input from the input unit 23 and transmitting the created printing job to the management server 1 by the terminal-communication unit 21. The output destination of a printing job of the printer driver 241 installed in each of the plurality of user terminals 2 is set to the common queue 122 of the management server 1. Therefore, the serviceperson can deploy a printer driver 241 collectively to a plurality of user terminals 2, and there is no need to change the setting of the output destination for each individual printer driver. The printer driver 241 is in an installed state in the user terminal 2.

The browser 242 is an application program for causing the display unit 22 to display a web page in HTML format or the like.

The document creation software 243 is an application program for viewing, editing and creating document data in Word (registered trademark) format or the like of Microsoft Corporation (registered trademark), for example.

A startup operation of the browser 242 or the document creation software 243 is performed via the input unit 23. Then, the terminal-control unit 25 reads the browser 242 or the document creation software 243 stored in the terminal storage unit 24, develops it in the RAM, and executes it, thereby activating the browser 242 or the document creation software 243. As a result, the user, by using the browser 242 or the document creation software 243, can cause the display unit 22 to display image data, HTML data, document data, or the like (hereinafter referred to as “document data”), and can perform browsing, editing or the like.

The terminal-control unit 25 is an information-processing unit such as a microcomputer or the like including a CPU, a ROM, a RAM and the like. The ROM stores a control program for performing operation control of the user terminal 2. The CPU of the terminal-control unit 25 reads the control program stored in the ROM, develops the control program in the RAM, and executes the control program, thereby performing overall control of the user terminal 2.

In addition, the terminal-control unit 25 functions as an individual-queue-setting unit 251 and a printing-job-creating unit 252.

The individual-queue-setting unit 251, based on the operation instruction from the input unit 23, has a function of communicating with the management server 1 via the terminal-communication unit 21 and setting the individual queue 123 as the output destination of a printing job by the user. Since the output destination of the printer driver 241 is set in the common queue 122, the printing job is moved from the common queue 122 to the individual queue 123 of the image forming apparatus 3 desired by the user.

The printing-job-creating unit 252 has a function of creating a printing job that causes document data to be printed in the case where there is an instruction to print document data that is being browsed or edited using the browser 242 or the document creation software 243. In the case where there is an instruction to print document data, the terminal-control unit 25 reads the printer driver 241 stored in the terminal-storage unit 24, develops the printer driver 241 in the RAM, and executes the printer driver 241, thereby activating the printer driver 241. As a result, the terminal-control unit 25 functions as a printing-job-creating unit 252 that realizes the function of the printer driver 241.

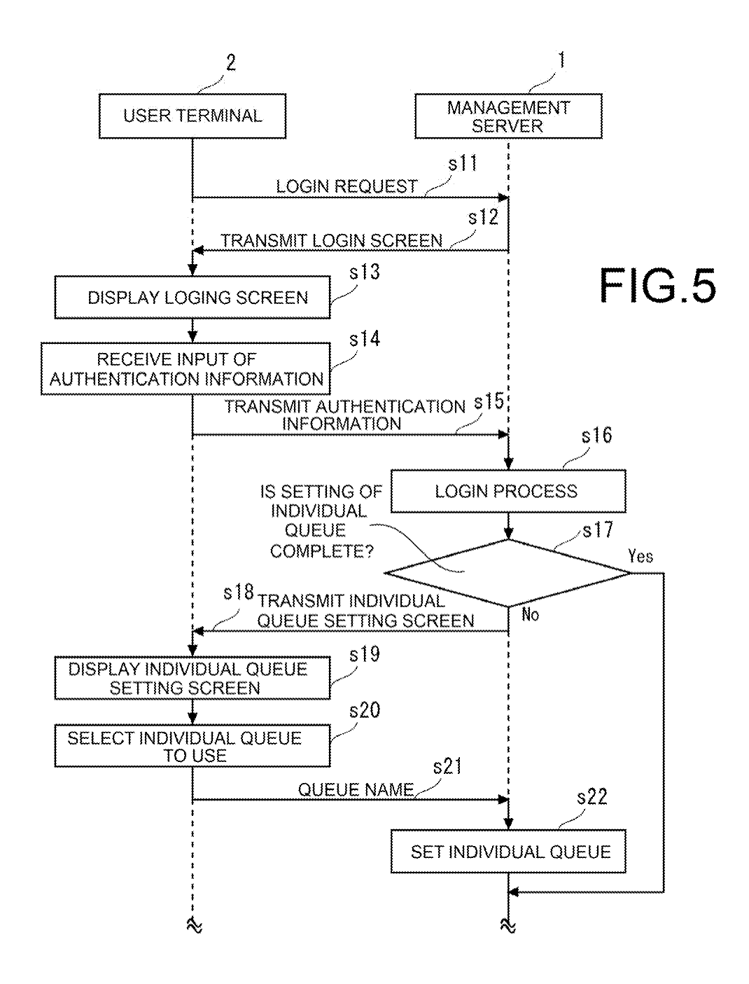

Next, a flow of processing for setting the individual queue 123 as the output destination of a printing job by a user will be described with reference to FIG. 5.

The individual-queue-setting unit 251 of the user terminal 2 transmits a login request to the management server 1 based on an operation instruction of the user via the input unit 23 (s11). Continuing, the authentication unit 131 of the management server 1, in response to the login request, transmits a login screen to the user terminal 2 (s12). Incidentally, the management server 1 may function as a web server.

Next, the individual-queue-setting unit 251 of the user terminal 2 displays the login screen on the display unit 22 (s13), and receives input of authentication information (s14). When authentication information such as a user name or the like is inputted on the login screen, the individual-queue-setting unit 251 of the user terminal 2 transmits the inputted authentication information to the management server 1 (s15).

The authentication unit 131 of the management server 1 executes a login process based on the authentication information transmitted from the user terminal 2 (s16). In the login process, the authentication unit 131 of the management server 1 executes user authentication by comparing the authentication information transmitted from the user terminal 2 with user information 121 stored in the server-storage unit 12. As a result, the authentication unit 131 allows the user who has succeeded in user authentication to log in to the management server 1, and permits browsing of various information correlated with the user and receiving of settings.

Note that in the case where user authentication fails, the authentication unit 131, without receiving login of the user, may notify the user terminal 2 that user authentication has failed and transmit the login screen again.

Continuing, the individual-queue-setting-receiving unit 132 of the management server 1 refers to the individual queue setting information 124 and determines whether or not the logged-in user has already set the individual queue 123 as the output destination of printing jobs (s17).

When the individual queue 123 is set (s17: YES), this process ends.

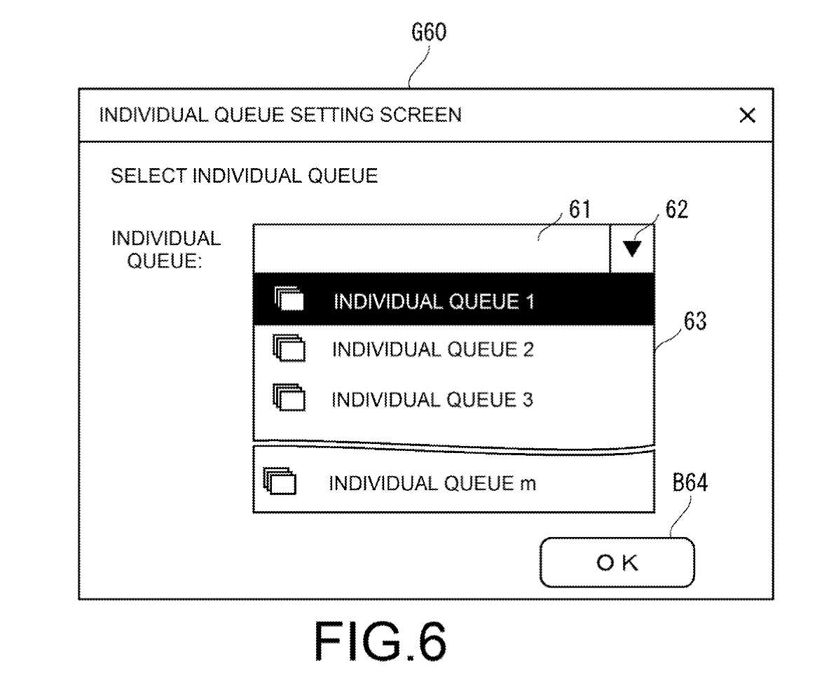

On the other hand, in the case where the individual queue 123 is not set in the individual queue setting information 124 as the output destination of the user's printing jobs (s17: NO), the individual-queue-setting-receiving unit 132 transmits the individual-queue-setting screen G60 illustrated in FIG. 6 to the terminal 2 (S 18).

The individual-queue-setting unit 251 of the user terminal 2 displays the individual queue setting screen G60 transmitted from the management server 1 on the display unit 22 (s19).

On the individual queue setting screen G60, an input field 61 for the user to input the individual queue 123 as the output destination of printing jobs, a list-display button 62 for displaying a list 63, the list 63 that displays a list of a plurality of individual queues 123, and an OK button B64 are arranged.

By operating the list-display button 62 and displaying the list 63, the user can select an individual queue 123 from the list 63 as the output destination. Moreover, by operating the list-display button 62 in a state where a part of the queue name is entered in the input field 61, only the individual queue 123 including the inputted queue name can be displayed in the list 63. When the user selects the desired individual queue 123 from the list 63, the queue name of the selected individual queue 123 is inputted into the input field 61. In the case where the queue name of the individual queue 123 to be the output destination is known beforehand, the queue name of the individual queue 123 of the output destination can be directly inputted into the input field 61.

Incidentally, a list of the individual queues 123 to be displayed in the list 63 may be generated by the individual-queue-setting-receiving unit 132 of the management server 1 each time the list-display button 62 is operated, or may be generated by the individual-queue-setting unit 251 of the user terminal 2. In the case when generated by the individual-queue-setting unit 251, a list of all the individual queues 123 may be received in advance from the individual-queue-setting-receiving unit 132 together with the individual queue setting screen G60. Note that a search of the individual queues 123 including the queue name may be a forward-match search, a partial-match search, or a backward-match search.

When the OK button B64 is operated in a state where the individual queue 123 is inputted in the input field 61, the individual-queue-setting unit 251 of the user terminal 2 transmits the queue name of the individual queue 123 inputted into the input field 61 via the individual queue setting screen G60 to the management server 1 (s21).

The individual-queue-setting-receiving unit 132 of the management server 1 correlates the queue name of the individual queue 123 transmitted from the user terminal 2 with the user and registers the queue name in the individual queue setting information 124 (s22), then this process ends.

As a result, each user can access the management server 1 via the user terminal 2 and set the individual queue 123 as the output destination of printing jobs.

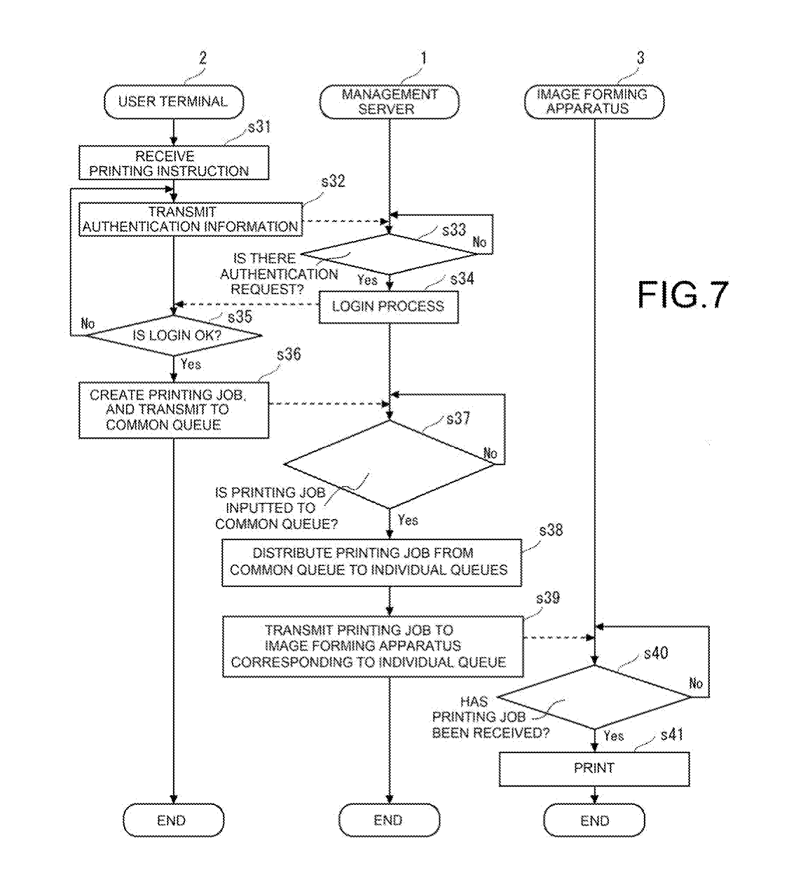

Next, the flow of the printing process of the image forming system X will be described with reference to FIG. 7.

Upon receiving a printing instruction from a user via the input unit 23 (s31), the printing-job-creating unit 252 of the user terminal 2, by the terminal-communication unit 21, transmits authentication information such as a user name or the like inputted via the input unit 23 to the management server 1 (s32).

The authentication unit 131 of the management server 1 stands by until an authentication request is received from the user terminal 2 (s33, s33: NO), and in the case where there is an authentication request (s33: YES), executes a login process based on the authentication information transmitted from the user terminal 2 (s34).

In the login process, the authentication unit 131 performs user authentication by comparing the authentication information transmitted from the user terminal 2 with the user information 121, and logs in the user who succeeds in user authentication. The user authentication result by the authentication unit 131 is transmitted to the user terminal 2 via the server-communication unit 11.

Based on the login result notification from the management server 1, the printing-job-creating unit 252 of the user terminal 2 determines whether or not login is OK (s35). In the case where the login has failed (s35: NO), the printing-job-creating unit 252 may return the process to s32 to transmit the authentication information and prompt the user to perform login again.

On the other hand, in the case where login is OK (s35: YES), the printing-job-creating unit 252 creates a printing job based on a printing instruction, and by the terminal-communication unit 21 transmits the created printing job to the common queue 122 of the management server 1 (s36). When doing this, the printing-job-creating unit 252 includes the logged-in user name in the printing job and transmits the printing job to the common queue 122.

The printing-job-distributing unit 133 of the management server 1 monitors the printing job storage state of the common queue 122 and stands by until a printing job is inputted to the common queue 122 (s37, s37: NO). Since all output destinations of the printer driver 241 installed in each user terminal 2 are set in the common queue 122, all printing jobs received by the server-communication unit 11 are stored in the common queue 122.

A printing job is inputted into the common queue 122 (s37: YES). Then, the printing-job-distributing unit 133, based on the individual queue setting information 124, specifies the individual queue 123 correlated with the user name included in the printing job. Then, the printing-job-distributing unit 133 distributes the printing job in the common queue 122 to the specified individual queue 123 (s38). As a result, the printing job is moved from the common queue 122 to the individual queue 123.

Continuing, the printing-job-transmitting unit 134 transmits the print job stored in the individual queue 123 to the image forming apparatus 3 corresponding to the individual queue 123 by the server communication unit 11 (s39).

The image forming apparatus 3 stands by until a printing job is received from the management server 1 via the network 5 (s40, s40: NO).

Upon receiving the print job (s40: YES), the image forming apparatus 3 executes and prints the printing job (s41). This completes this process.

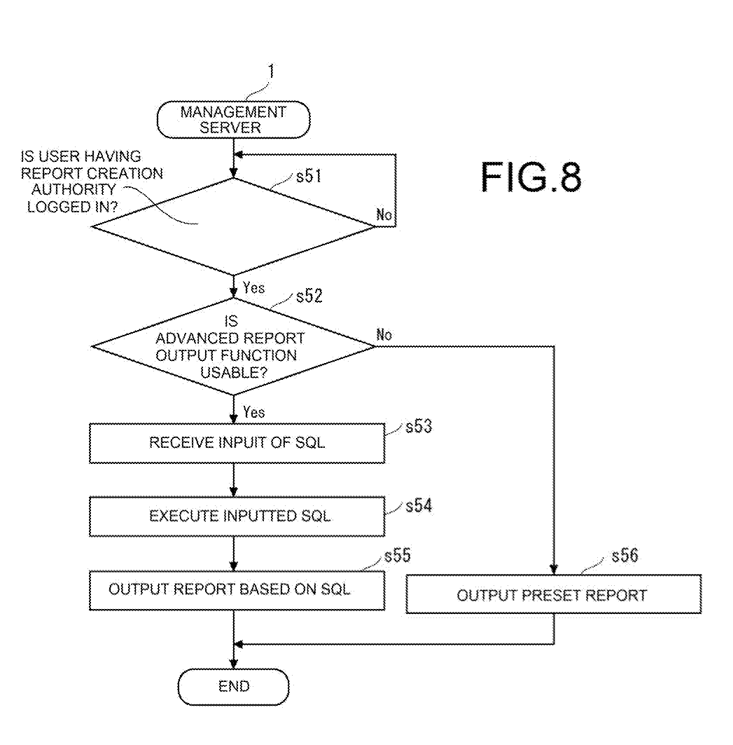

Next, the flow of the report generation process by the management server 1 will be described with reference to FIG. 8.

The report-generating unit 136 stands by until a user having the report creation authority logs in by the authenticating unit 131 (s51, s51: NO). A user having report creation authority is, for example, an administrator of the management server 1 or a user who is given report creation authority by an administrator or the like. By giving report creation authority to a user, the user himself/herself can set the filtering condition by SQL and improve the flexibility. Incidentally, in the following description, it is presumed that an administrator has logged in.

When a user having report creation authority logs in (s51: YES), the report-generating unit 136 determines whether or not the advanced report output function can be used (s52). For example, in the case where an administrator writes a specific command for setting the advanced report output function to be usable in the system setting file of the management server 1, the report-generating unit 136 may determine that the advanced report output function is usable.

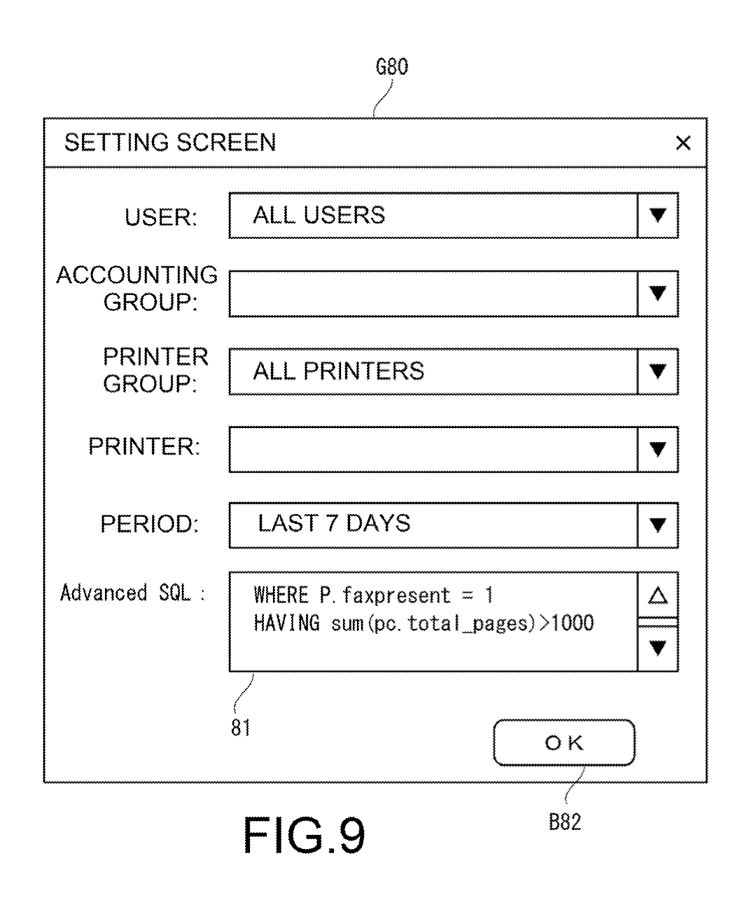

In the case where the advanced report output function is usable (s51: YES), the report-generating unit 136 transmits the setting screen G80 illustrated in FIG. 9 to an administrator terminal 4 and receives input by SQL, which is a database language (s53).

On the setting screen G80, it is possible to filter the items to be displayed on the report. In the case where the advanced report output function is usable, an SQL input field 81 in which SQL can be inputted is placed on the setting screen G80, and a filter condition can be set using a WHERE clause or a HAVING clause. For example, as illustrated in FIG. 9, of the image forming apparatuses 3 having a FAX function, it is possible to filter out only image forming apparatuses 3 whose total number of print pages is 1000 pages or more as the target of a report. Therefore, it is possible to flexibly change the report items, and it is possible to freely input conditions instructed by a customer, conditions for identifying problems of a customer environment, and the like.

When the OK button B82 on the setting screen G80 is operated, the report-generating unit 136 determines that there is an instruction to generate a report, and based on the filter condition set on the setting screen G80, executes the SQL inputted in the SQL input field 81 (s54).

Continuing, the report-generating unit 136, by executing the SQL, identifies the target of the report from the management information DB 125, and outputs a report based on the SQL to the administrator terminal 4 (s55), after which this process ends.

On the other hand, in the case where the advanced report output function is not usable (s51: NO), the report-generating unit 136 identifies the target of the report from the management information DB 125 under a preset filtering condition, and outputs the preset report to the administrator terminal 4 (s56), after which this process ends. In the case where the advanced report output function is not usable, the report-generating unit 136 may display a setting screen G80 on which the SQL input field 81 is unusable on the administrator terminal 4, and receive the setting of the filter item. In this case, the administrator can output a report with a simple filtering setting.

As described above, the management server 1 is a management server 1 that manages a plurality of image forming apparatuses 3 via a network, and includes a management information database (management information DB 125) in which job histories of a plurality of image forming apparatuses 3 are registered, a filtering-setting-receiving unit 135 that receives a filtering setting for the management information database by SQL, and a report-generating unit 136 that executes the SQL received by the filtering-setting-receiving unit 135 for the management information database and generates a report based on the job histories. As a result, the administrator can flexibly set the filtering condition according to a request from the customer, and can easily output the report requested by the customer.

Incidentally, the individual-queue-setting unit 251 may be included in the function of the printer driver 241. For example, when the user terminal 2 first activates the printer driver 241, the terminal-control unit 25 may function as the individual-queue-setting unit 251. Then, the individual-queue-setting unit 251 may perform user authentication with the management server 1, receive the individual queue setting screen G60, and cause the individual queue setting screen G60 to be displayed on the display unit 22, and prompt the user to set the individual queue.

Moreover, before transmitting a printing job to the image forming apparatus 3 corresponding to the individual queue 123, the printing-job-transmitting unit 134 of the management server 1 may determine whether or not the image forming apparatus 3 as the transmission destination can print the printing job to be transmitted in its printing setting. Then, in the case where printing is not possible, the printing-job-transmitting unit 134 without transmitting the printing job to the image forming apparatus 3, may notify the user who created the print job by e-mail or the like that the printing settings are inappropriate. In addition, instead of determining whether or not the printing-job transmitting unit 134 can print, the image forming apparatus 3 may determine whether or not the printing job transmitted from the printing-job-transmitting unit 134 can be executed. Then, in the case where printing is not possible, the printing-job-transmitting unit 134, may, by e-mail or the like, notify the user who created the printing job that the printing settings are inappropriate.

In a typical technique, fields and parameters that are to be the object of a report are determined in advance, and there is a problem in that it is not possible to flexibly filter report items under various conditions according to the customer environment.

With the technique according to the present disclosure, it is possible to flexibly filter report items under various conditions according to the customer environment.

The technique according to the present disclosure is not limited to the above-described embodiments, and it goes without saying that various modifications can be made without departing from the gist of the present disclosure.

What is claimed is:

1. A management server that manages a plurality of image forming apparatuses via a network, comprising:
a management information database in which job histories of a plurality of image forming apparatuses are registered;
a filtering-setting-receiving unit that receives a filtering setting for the management information database by SQL; and
a report-generating unit that executes the SQL received by the filtering-setting-receiving unit for the management information database and generates a report based on the job histories.

2. The management server according to claim 1, wherein
the filtering-setting-receiving unit
receives the filtering setting via a setting screen on which a SQL input field into which the SQL is inputted is arranged.

3. The management server according to claim 1, wherein
the filtering-setting-receiving unit,
in the case where a specific command is written in a system setting file of the management server, receives the filtering setting by SQL.

4. The management server according to claim 1, wherein
the filtering-setting-receiving unit,
receives the filtering setting using WHERE clauses and HAVING clauses.

5. An image forming system in which a plurality of image forming apparatuses and a management server are connected via a network, wherein
the management server comprises:
a management information database in which job histories of a plurality of image forming apparatuses are registered;
a filtering-setting-receiving unit that receives a filtering setting for the management information database by SQL; and
a report-generating unit that executes the SQL received by the filtering-setting-receiving unit for the management information database and generates a report based on the job histories.

6. A management method executed by a management server that manages a plurality of image forming apparatuses via a network, comprising the steps of:
receiving by SQL a filtering setting for a management information database in which job histories of the plurality of image forming apparatuses are registered; and
executing the received SQL for the management information database and generating a report.
